(19) United States
(12) Patent Application Publication
(10) Pub. No.: US 2004/0227931 A1
(43) Pub. Date: Nov. 18, 2004

(54) Optic communication or transmission media sensing

(76) Inventors: Stuart John Russell, Southampton (GB); Justin Peter William Hayward, Southampton (GB); John Phillip Dakin, Romsey (GB)

Correspondence Address: BAKER & HOSTETLER LLP, Washington Square, Suite 1100, 1050 Connecticut Avenue, N.W., WASHINGTON, DC, 20036, US

(21) Appl. No.: 10/439,335

(22) Filed: May 16, 2003

(51) Int. Cl. G01N 21/00

(52) U.S. Cl. 356/73.1

(57) ABSTRACT

An apparatus and method are provided for detecting disturbances (changes in physical configuration) in optic communication or transmission media such as fibre-optic cables 180 has a source 110 of pulsed laser light, a circulator 150 for inputting the pulsed laser light into the fibre-optic cable and receiving backscattered radiation from the cable 180, and a detection stage 160 for detecting the amplitude of radiation backscattered from the cable 180 as a function of time, the backscattered radiation being caused by pulses of laser light input into the cable 180 at a first end. The results may be analysed and may be correlated to indicate the existence and/or location of a disturbance. A method of detecting such disturbances is also disclosed.

### FIELD OF THE INVENTION

The present invention relates to remote detection of the location of a disturbance or change in physical configuration of an optic communication or transmission media such as a fibre-optic cable.

### BACKGROUND OF THE INVENTION

Optical fibres contain microscopic inhomogeneities in the refractive index of the material. These inhomogeneities are typically less than an optical wavelength in size, and are fixed in the material of the fibre on manufacture. Inhomogeneities, with a very small refractive index difference such that the optical phase change is less than λ/10 compared with the average refractive index, give rise to similar backscattering.

These mechanisms set a theoretical minimum attenuation in fibre-optic cables due to statistical fluctuations of the refractive index.

It can be shown that, where a pulse of Gaussian beam profile with a temporal width τ is launched down the fibre, the total backscattered power Pₛ at time t is given by:

$${P}_{s} = \frac{1}{2} {α}_{s} {v}_{g} τ {P}_{0} {ⅇ}^{- α {v}_{s} t} S \qquad [ 1 ]$$

where αₛ is the attenuation constant representing loss due to Rayleigh scattering, v_{g} is the group velocity of light in the core, P₀ is the power launched at the sending end of the fibre, α is the overall attenuation constant (for modern fibres α =αₛ) and S is the fraction of the scattered light which is recaptured by the fibre in the reverse direction.

For a step-index signal-mode fibre it can be shown that:

$$0.21 \frac{{n}_{1}^{2} - {n}_{2}^{2}}{{n}_{1}^{2}} \leq S \leq 0.24 \frac{{n}_{1}^{2} - {n}_{2}^{2}}{{n}_{1}^{2}} \qquad [ 2 ]$$

wherein n₁ and n₂ are the core and cladding refractive indices respectively. For a typical telecommunications fibre n₁=1.46 and n₂=1.44. Taking these values and assuming a mid-point coefficient of

$$\frac{0.21 + 0.24}{2}$$

gives S≈32 0.0063.

The above analysis assumes an incoherent source is used to generate the pulse. However, this is not necessarily the case; some types of source have coherence lengths of several kilometres. Coherent illumination causes a change in the properties of the Rayleigh backscatter. The illumination can be said to be coherent when the coherence length is longer than the pulse length. Because each scattering point is excited from a coherent source, the scattered light interferes, constructively or destructively, resulting in localised maxima and minima in the backscatter trace: this phenomenon is referred to as coherence noise or “fading” noise. As the characteristics of the backscatter trace are determined by the relative phase relations of a large number of backscattered waves from fixed locations, the short-term signal is stable unless the phase relations are changed. It is therefore not possible to remove fading noise simply by averaging over a large number of pulses, but some parameter which changes the phase relation between scattering sites must be varied over the averaging, most commonly the wavelength of the incident light.

By launching a pulse of light down the fibre and using time-of-flight analysis, the spatial location of optical features can be found. This technique is known as Optical Time Domain Reflectometry.

Conventional Optical Time-Domain Reflectometry (OTDR), makes use of pulses of incoherent radiation successively input into a fibre-optic cable. The backscatter of the pulses, caused by the inhomogeneities in the cable, is detected and the amplitude of the backscattered radiation is averaged over many pulses to obtain an attenuation profile for the cable.

However, conventional OTDR is strain sensitive only where the strain impairs the guiding properties of the fibre. Also, very many pulses must be used in order to obtain a sufficient signal to noise ratio, and so the technique is unsuitable for audio frequency measurements.

It is an object of the invention to provide an improved system for remote detection of the presence and/or location of a disturbance i.e. a change in physical configuration of optic communication or transmission media such as a fibre-optic cable.

### SUMMARY OF THE INVENTION

The present invention provides a method and apparatus for sensing disturbances in an optic communication or transmission media such as a fibre optic cable. Such a fibre can be used in a variety of technical fields, for example, the communication industry in order to prevent damage by excavation, or sensing technologies e.g. stretch sensors. Pulses of coherent light are input to the media. Radiation from the pulses is backscattered by inhomogeneities in the media and the backscattered radiation from the pulses is detected and compared or correlated for different pulses.

The invention provides an apparatus and method which in one embodiment can detect small strains in a fibre-optic cable. In an embodiment of the invention, this is done by sending a pulse of radiation along the fibre-optic cable, and detecting the backscattered signal from the input pulses as a function of time, rather than averaging the backscattered amplitude over many pulses. Therefore, varying strains on the fibre, which displace a number of the scattering inhomogeneities in the fibre and thus cause local variations in the backscatter trace, can be detected as an intensity modulated signal directly related to the strain at that location.

The pulse can also be compared with a reference of backscattered radiation from the cable, or a derived version of the reference, in order to indicate a disturbance by any differences between the reference and the backscatter from the pulse.

In an embodiment of the invention, a plurality of pulses can be input into a fibre-optic cable, and comparison and/or correlation analysis can be carried out on these pulses to determine the location of a change in the physical configuration of the fibre-optic cable. Correlation of backscatter from multiple pulses gives an accurate result on the location and/or existence of a strain because random features of single backscatter profiles for each pulse can be ignored and strains detected over more than one pulse can be emphasised without averaging over many pulses, which would destroy the location information held in the delay between input of the pulse and detection of the backscattered radiation. If identical pulses are sent down the fibre-optic cable, then the backscattered radiation caused by each pulse received by the detector, as a function of time, should also be identical, as the inhomogeneities are fixed in the fibres on manufacture.

However, if there is a disturbance to the fibres, such as a strain or bend in the cable, there will be a change in the configuration of the inhomogeneities within the fibres, causing an alteration in intensity of the backscattered radiation as a function of time. This will cause a reduction in the correlation of backscattered pulses as the configuration of the cable changes.

Such a reduction of correlation can indicate not only that a disturbance is occurring, but also the location of the disturbance, due to the fact that the backscattered radiation is detected as a function of time, and the time taken for the backscattered radiation to return to the input end of the cable is indicative of the distance along the cable from the input end that the disturbance occurs.

The pulses can be input to the cable at acoustic frequencies to identify acute disturbances to a cable, for example excavation of the ground surrounding or close to the cable.

The pulses can be input to provide continuous monitoring of a cable, so that any disturbance can be detected as soon as it occurs. With such monitoring, as well as acute disturbances, long term changes in the configuration of the cable, caused by slowly altering physical effects such as subsistence and shifting of the ground in which the cable is buried, can be monitored. Such monitoring could be carried out by correlating between pulses over longer time periods, for example days, weeks or months.

An embodiment of the invention has a source of pulses of coherent radiation. The pulses may be of a duration in the range of 50 ns to 50 μs. The range of duration may also be between 100 ns and 1 μs, or between 150 ns and 500 ns. The range of durations may be any non-zero time up to the pulse repetition rate. The spatial resolution is proportional to the pulse duration.

In an embodiment of the invention, the source comprises a laser generator, an amplifier and a high speed switch to pulse the laser generated beam. A pulsed beam generator may alternatively be used, or the pulses may be generated remote to the apparatus of the invention. All that is needed is a source of pulses of coherent radiation.

An embodiment of the invention also has an input and receiving stage, which may be comprised in a single unit. This unit may be a circulator. Alternatively, the input and receiving stage may be separate input and receiving units. This stage may also comprise an output unit.

An embodiment of the invention comprises a detection stage to detect the backscattered radiation from the pulses. The detection stage may include only a detector to detect the backscattered radiation from each pulse. The detector detects the intensity of the backscattered radiation. The detection stage may also comprise a processor to process the detected backscatter from the pulse as a function of time and may also correlate the backscatter with previous pulses and may give a signal indicative of the presence of a disturbance and/or its location.

The invention, in particular the detection stage, may also have one or more sample-and-hold amplifiers, which provide samples of the backscattered radiation from the pulses at predetermined times.

Alternatively, the processing of the detected backscatter may be processed externally to the invention, with only raw data being output from the apparatus of the invention.

Alternatively, digital signals may be processed, rather than analogue signals.

One or more computers or dedicated processors can be used to control some or all aspects of the invention.

One or more processors may also be used to calculate the comparison or correlation between backscatter caused by the pulses and to give an indication of the existence and/or location of a disturbance.

The invention also consists in other combinations of individual features not explicitly described herein.

For the avoidance of doubt, the fibre-optic cable itself does not form part of embodiments of the invention, but is used with the invention, and disturbances on the cable detected and/or located by the invention. Additionally, although a fibre-optic cable has been referenced to be used with the invention, other types of optical communication or transmission media may be used, if the features of the media are static or predictable.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

Embodiments of the invention will now be described, purely by way of example, with reference to the accompanying drawings, in which:

FIG. 1 shows a diagram of an apparatus according to a first embodiment of the invention;

FIG. 2 shows a flow diagram showing a method of operation of the first embodiment of the invention;

FIG. 3 shows a flow diagram showing the operation of a source of the first embodiment of the present invention;

FIG. 4 shows a flow diagram showing the operation of a detection stage of the first embodiment of the present invention;

FIG. 5a shows a schematic graph representative of the backscattered radiation obtained from a cable and detected by the first embodiment of the invention as a function of time;

FIG. 5b shows a further schematic graph representative of the backscatter from pulses input into a cable and detected by the first embodiment of the invention as a function of time at a different time from the same cable;

FIG. 6 shows a schematic graph of correlation of the graphs of FIGS. 5a and 5b;

FIG. 7 shows a flow diagram according to a second embodiment of the invention; and

FIG. 8 shows an apparatus according to a third embodiment of the invention.

### DETAILED DESCRIPTION

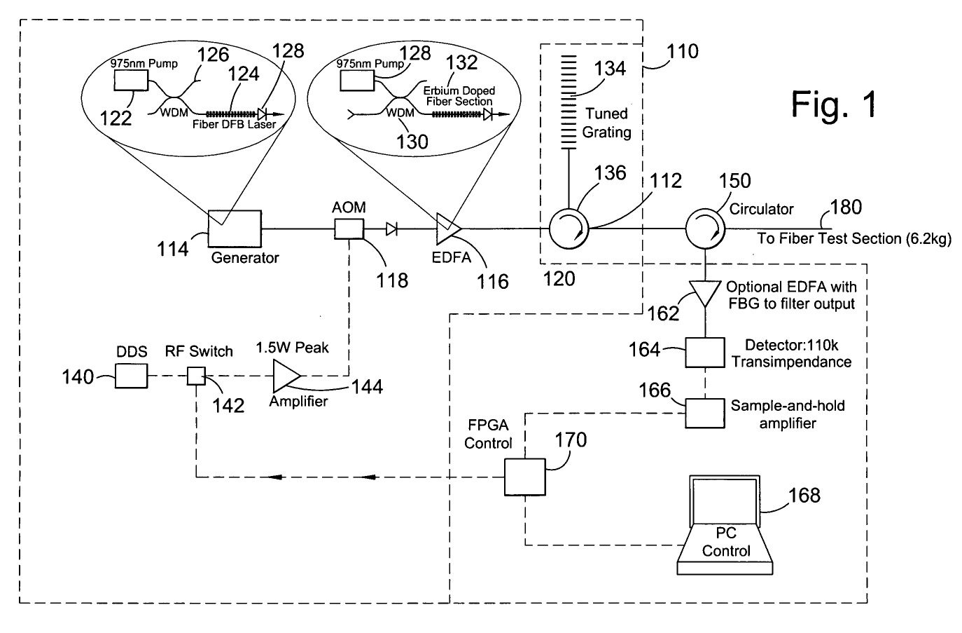

FIG. 1 shows an apparatus according to a first embodiment of the invention. The apparatus comprises a source 110, a circulator 150 and a detection stage 160.

The source 110 has an output 112, which provides pulses of coherent radiation, and the source output 112 is optically coupled to the circulator 150. The circulator 150 is also optically coupled to the detection stage 160, and to a fibre optic cable 180. The circulator 150 directs radiation from the source 110 into the fibre-optic cable 180 and receives radiation returned from the fibre-optic cable 180 and directs the received radiation into the detection stage 160.

The circulator 150 has an input stage and a receiving stage, which input the pulses into the fibre-optic cable 180 and receives the backscattered radiation caused by the pulses from the cable 180 respectively. In the first embodiment, the input stage and receiving stage is the same unit. However, alternatively, separate units could be provided to perform the same function.

The detection stage 160 detects the intensity of the backscattered radiation input from the circulator 150 as a function of time.

In addition to the output 112, the source 110 comprises a light generator 114 supplying an erbium doped fibre amplifier (EDFA) 116 via an accousto-optic modulator (AOM) 118. The EDFA 116 is connected to a bandpass filter 120 which comprises output 112.

The light generator 114 comprises a pump 122 supplying a fibre distributed feedback laser 124 via a Wavelength Division Multiplexer (WDM) 126 coupled between the two and an isolator 128. The pump 122 generates radiation at a wavelength of 975 nm. Other frequencies of radiation could also be generated by using a different pump and WDM and laser. The radiation generated by the pump 122 is fed into the WDM 126 and from there into the laser 124. The laser 124 then outputs a beam of radiation at a wavelength of 1550.116 nm. The isolator 128 prevents radiation returning into the laser 124. Wavelengths other than this could also be used in the invention.

The radiation output from the generator 114 is controlled by AOM 118 which pulses the beam from the generator 114. The AOM 118 is controlled by a Radio Frequency (RF) switch 142, which modulates a signal generated by a DDS (direct digital synthesiser) 140, and the modulated signal produced by the RF switch 142 acting on the generated signal is amplified by an amplifier 144 to a power of 1.5 W peak before being input into the AOM 118. AOM 118 is driven at 110 MHz with the RF switch turning the 110 MHz signal on and off, but other frequencies could alternatively be used, as appropriate. Other sources producing pulsed laser radiation could also be used in the invention.

The RF switch 142 is controlled by a control stage 170. The control stage 170 controls the opening ratio and timing of the AOM 118 via the RF switch 142. The control stage 170 is also connected to the detection stage 160 so as to synchronise the source 110 and detection stage 160.

The EDFA 116 comprises a second pump 128 at the same wavelength as the first pump 122. Other wavelengths could also be used. An erbium doped fibre section 132 is connected to the second pump 128, via a second WDM 130, and amplifies the pulses from the AOM 118. In the present embodiment, output from the EDFA 116 is then passed through the narrow bandpass filter 120. The bandwidth of the filter 120 is, in the present embodiment, 0.3 nm. The filter 120 comprises a fibre Bragg grating (FBG) 134, and a circulator 136. The FBG 134 removes amplified spontaneous emission (ASE) from the EDFA 116 and only allows light within the bandwidth to re-enter the circulator 136 and be output from the output 112 of the source 110.

The EDFA 116 gives a gain of 30 dB with pulses 200 ns in duration. An AOM 118 with a 90% transition time of ˜25 ns and a separation between pulses of at least 50 μs is provided.

The pulses produced by the source 110 are at a power such that non-linear effects are small. The source produces pulses of ˜1 W for ˜200 ns, which gives an average energy of the pulses of 0.2 μJ, keeping non-linear effects low and within tolerances.

The pulses output from the source 110 at output 112 are input into an input and receiving stage, which in this embodiment is the circulator 150. The circulator 150 inputs pulses received from the source 110 into the fibre optic cable 180, to which the circulator 150 is coupled.

A proportion of the radiation backscattered within the fibre-optic cable 180 is received back at the circulator 150. This backscattered radiation is output from the circulator 150 to the detection stage 160.

The detection stage 160 comprises a further EDFA 162 to amplify the signal from the circulator 150. The further EDFA 162 is the same as EDFA 116 in the source 110, except that a fibre Bragg grating (not shown), which is the same as grating 120, is included within the further EDFA 162.

Alternatively, the further EFDA 162 may be omitted, if the intensity of the backscattered radiation from the fibre-optic cable 180 is sufficient for detection to be achieved without the further EDFA, at a suitable signal to noise ratio.

A detector 164 is connected to the output of the further EDFA 162 and the signal output from the detector 164 is output to a sample-and-hold amplifier 166, which is controlled by the control stage 170, which in this embodiment comprises a FPGA controller, to sample the signal from the detector 164 at a particular time.

The sample-and-hold amplifier 166 is thus synchronised with the AOM 118 of the source 110, so that the time after the pulse enters the fibre-optic cable 180 is known, and the time delay from entry into the fibre-optic cable 180 to backscatter to the detection stage 160 is also known. The distance along the fibre 180 that the pulse has travelled before being backscattered can be determined from the time delay. The sample-and-hold amplifier is timed to capture the signal from a specific region of the fibre. More than one sample-and-hold amplifier may be used, and these may be used to capture signals from more than one region of the fibre.

The signal sampled by the sample-and-hold amplifier 166 is input into the control stage of the FPGA controller 170, which is, in turn, controlled by a PC control 168. The sampled signal is received by the PC control 168 and processed as will be described below.

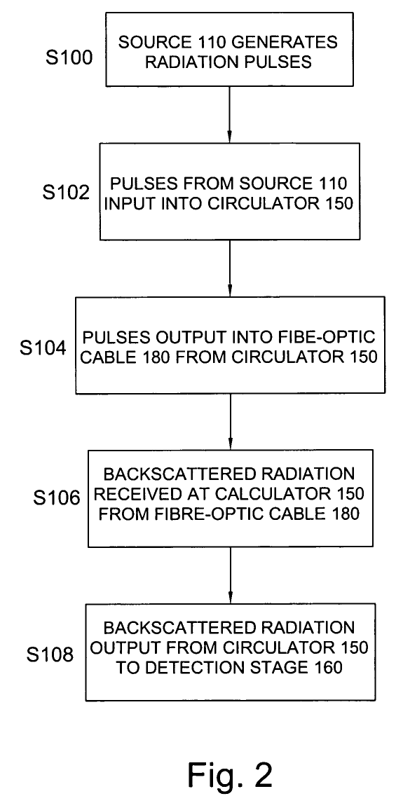

A method of operation of the first embodiment of the invention will now be described with reference to FIGS. 2 to 4 of the drawings.

FIG. 2 shows a flow diagram of an overall operation of the first embodiment.

The source 110 generates pulses at S100. Each pulse enters the circulator 150 at S102 and is output into the fibre-optic cable 180 at S104.

Each pulse travels along the fibre-optic cable 180, with some backscattering along its length. The backscattered radiation travels back along the fibre-optic cable 180, and re-enters the circulator 150 at S106. The circulator 150 outputs the backscattered radiation received to the detection stage 160, and the detection stage 160 detects the backscattered radiation, at S108.

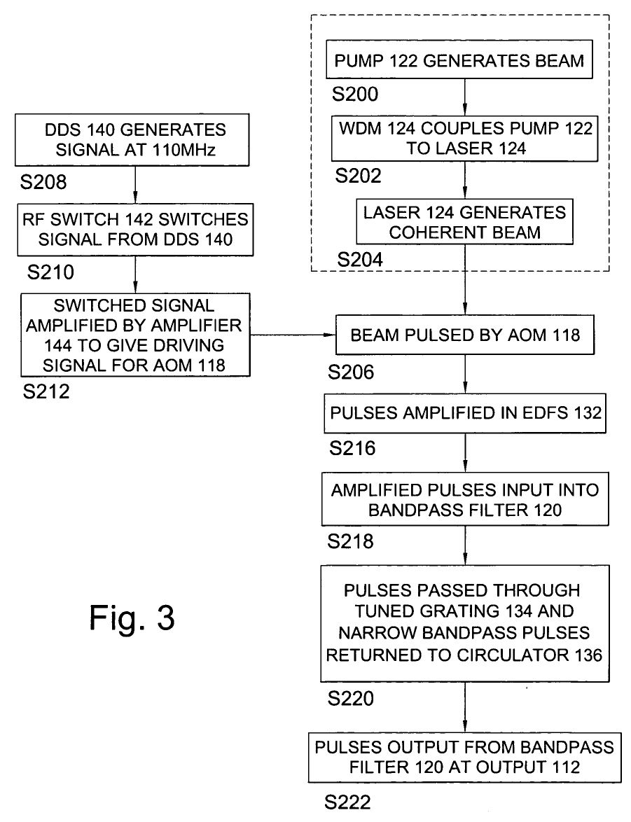

FIG. 3 shows a flow diagram showing a method of operation of the source 110 of the first embodiment.

Within the generator 114, the pump 122 creates light with a wavelength of approximately 975 nm at S200. The WDM 126 creates an output for pumping the DFB laser 124 at S202, and the fibre DFB laser 124 creates a coherent beam of radiation with a line width of approximately 30 kHz, giving a coherence length of over 6 km in fibre, which is output from the generator 114 at S204.

The beam from the generator 114 is then pulsed by AOM 118 at S206. AOM 118 is controlled by the control stage 170. The DDS 140 produces a RF signal at 110 MHz at S208. The RF switch 142, controlled by the control stage 170, switches the RF signal of the generated signal at S210. This signal is amplified by the 1.5 W peak amplifier 144 at S212.

The beam is therefore pulsed by the AOM 118 according to the RF switch 142 signal, which is controlled by the control stage 170. The AOM 118 provides pulses of a length of approximately 200 ns, with a separation between pulses of more than 50 μs.

The further EDFA 130 then amplifies the signal at S216. The amplified pulse, with a power of approximately 1 W, is then passed through the circulator 136 of the bandwidth filter 120 at S218. The pulse is filtered by the fibre Bragg grating 134 at S220, in order to remove amplified spontaneous emission noise from the EDFA 116.

The bandwidth of the filter is 0.3 nm and each pulse output from the source 110 has a duration of approximately 200 ns, which corresponds to a spatial extent of the pulse of 40 m within the fibre-optic cable 180. The power of the amplified source 110 is approximately 1 W, giving an energy of each pulse of 0.2 μJ. The wavelength of the input pulse is 1550.116 nm with a line width of 30 kHz.

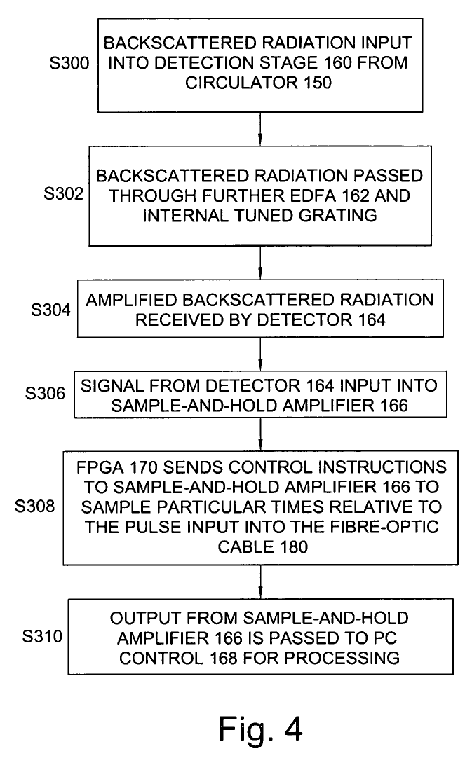

FIG. 4 shows a method of operation of the detection stage according to the first embodiment of the invention.

The backscattered radiation from the circulator 150 is input into the detection stage at S300. The radiation is passed through the further EDFA 162 at S302 to amplify the signal and filtered to remove any radiation at a wavelength of other than 1550.116 nm.

The amplified radiation is then input into the detector 164 at S304. In the present invention, the detector 164 is a fibre-coupled photodiode detector with a transimpedance of 110 kΩ. However, other detectors may also be used.

The detected signal is output from the detector 164 to the sample-and-hold amplifier 166 at S306. The sample-and-hold amplifier, comprises a sample-and-hold device, giving a small-signal bandwidth of 15 MHz. An 8^{th} order, progressive-elliptic, low-pass filter (Linear Technologies LTC1069-1) then removes signal components above 3 kHz, effectively smoothing the transitions between samples. The output is buffered by an op-amp stage giving 20 dB gain over 3 kHz bandwidth. The sample-and-hold device generates 150 μV RMS noise, the low-pass filter 110 μV RMS, and the operational amplifier 15 nV/\sqrt{Hz} at the input. Alternatively, a linear filter can be used.

The total RMS noise of the sample-and-hold amplifier is therefore:

10×[150²+110²+(0.015×\sqrt{3000})²]^{1/2}=1900 μV [3]

This is equivalent to an optical input of approximately 2 nW. This is two orders of magnitude smaller than the optical power required to give shot-noise limited detection (0.53 μW) so no significant noise is added by the sample-and-hold amplifier. The total noise is reduced because the detector noise above 3 kHz will be suppressed by the filter elements.

In order to satisfy the Nyquist criteria at the maximum signal frequency, the output must be sampled at a minimum of 6 kHz, setting the maximum sensor length to (Group velocity)×(Round trip duration)=

$$\frac{2 \times {10}^{8}}{2 \times 6000} = 17 km .$$

For example, with a 6.2 km fibre-optic cable 180, the repetition rate is 14 kHz. Longer sensors are possible by accepting a reduction in the sensor bandwidth.

The sample-and-hold amplifier 166 receives control instructions from the FPGA 170 at S308 to sample particular times relative to the pulse input into the fibre-optic cable 180.

The output from the sample-and-hold amplifier is then passed to the PC (control) 168 at S310 for processing.

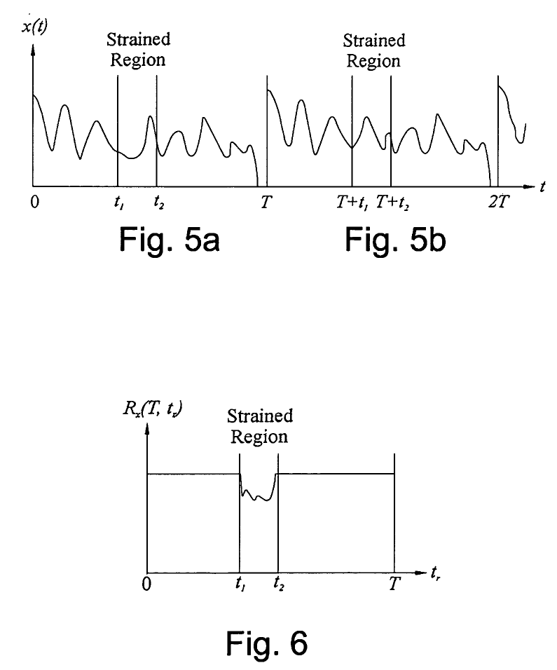

FIGS. 5a and 5b show schematic results representative of the first embodiment described above. These figures show that the graph of the intensity of the detected backscattered radiation against time differs between FIG. 5a and FIG. 5b.

Assuming that the pulse enters the fibre-optic cable at 0 in FIG. 5a and at T in FIG. 5b, in the region between t₁ and t₂ and T+t₁ and T+t₂, the signal is different, indicating that the physical configuration of the fibre-optic cable 180 has changed between 0 and T at a distance corresponding to the time t₁ taken for the pulse to travel along the fibre-optic cable 180 and back to the detector.

The two pulses can then be compared, and any detected differences used to indicate a disturbance of the fibre, and the region or location of the fibre at which the disturbance has occurred. In order to simply detect the existence of a change in the physical configuration of the fibre optic cable, the whole of the sum of backscattered radiation from each pulse may be compared.

A change in this sum between pulses can indicate a change in the physical configuration of the fibre. It is possible to sum the differences in the intensity of radiation backscattered by different pulses to obtain an indication of the strain in the fibre.

Further, in the above embodiment, an auto-correlation can be found between pulses. Such correlation is not essential to the invention.

The auto-correlation function can be defined as

Rₓ(τ)=<×(t)×(t+τ)>. [4]

The triangular brackets denote ensemble averaging, which may be approximated by a time average. In order to identify changes in the backscatter trace it is clearly only of interest to consider the case when τ=T. Disturbance location may be achieved by taking the average over a fraction of the total backscatter trace. The duration of the averaging period will limit the spatial resolution (assuming it is longer than the pulse duration). In order to maintain spatial resolution of the simple system the averaging should take place over the pulse duration, tₚ. Re-writing the average in terms of an integral, we therefore obtain that

$${R}_{x} ( τ = T , {t}_{r} ) = \frac{1}{{t}_{p}} {\int }_{{t}_{r}}^{{t}_{r} + {t}_{p}} x ( t ) x ( t + T ) ⅆ t \qquad [ 5 ]$$

where the time tᵣ gives the range. The signal is not continuous, but a digitally sampled signal and so the integral is replaced by summation over the requisite number of samples. The idealised result for the case of FIGS. 5a and 5b is shown in FIG. 6. The correlation is constant in the un-strained regions and reduces where the waveforms differ in the strained region.

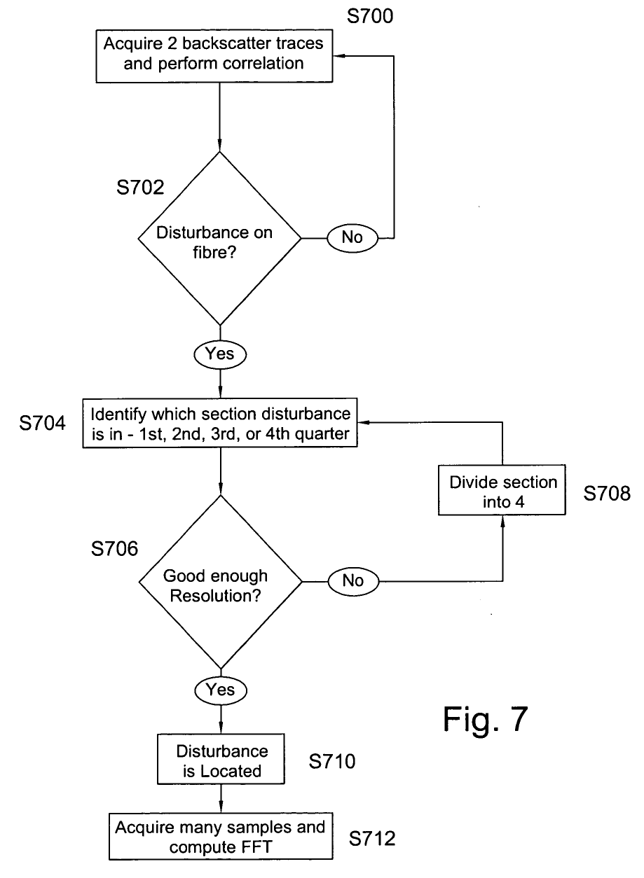

Implementing the above technique in real time requires high data processing rates. Therefore, a less computationally intensive algorithm for disturbance location may be used. A second embodiment of the present invention uses the first embodiment method and apparatus, but additionally divides the sensing fibre into a number of relatively large sections. The principle of this second embodiment is shown in a flow diagram in FIG. 7.

At S700 the PC control 168 chooses two different backscatter traces obtained from the detection stage 160. A correlation, as described above, or another correlation method, is carried out on the two traces.

The correlation result is analysed for any reduction in correlation, which would indicate a disturbance on the fibre-optic cable 180 at S702. If no reduction in the correlation is detected for the trace as a whole, the system returns to S700 and repeats.

If a reduction in correlation is detected, a disturbance is identified and the system detects which section the disturbance is in by breaking the backscattered trace into, for example, four regions separated by time, and analysing the correlation in each region until the region in which the fall in correlation occurred has been identified at S706.

The region identified as having the fall in correlation is then divided into four at S708, and S704 and S706 are then repeated.

The S706-S708 loop is repeated until the resolution of the disturbance is sufficient, at which point the disturbance is located at S710.

Finally, at S712 the whole sequence is repeated to give many samples, which are then fast fourier transformed to obtain a frequency spectrum of the signal.

Each of these can then be interrogated using the above correlation technique but with the averaging occurring over the whole section. When a disturbance is found in one of the sections the system then concentrates on this section, successively dividing it into smaller and smaller sections until the disturbance is located to sufficient spatial resolution. This process may be accomplished by either reprocessing the original data or using newly acquired data. Once the disturbance is located, a number of measurements can be made at that location to determine the frequency spectrum of the disturbance. Depending on the time taken to carry out these operations it may be desirable to periodically re-scan the entire fibre to detect any additional disturbances that could then be located in parallel, using a number of sample and hold amplifiers.

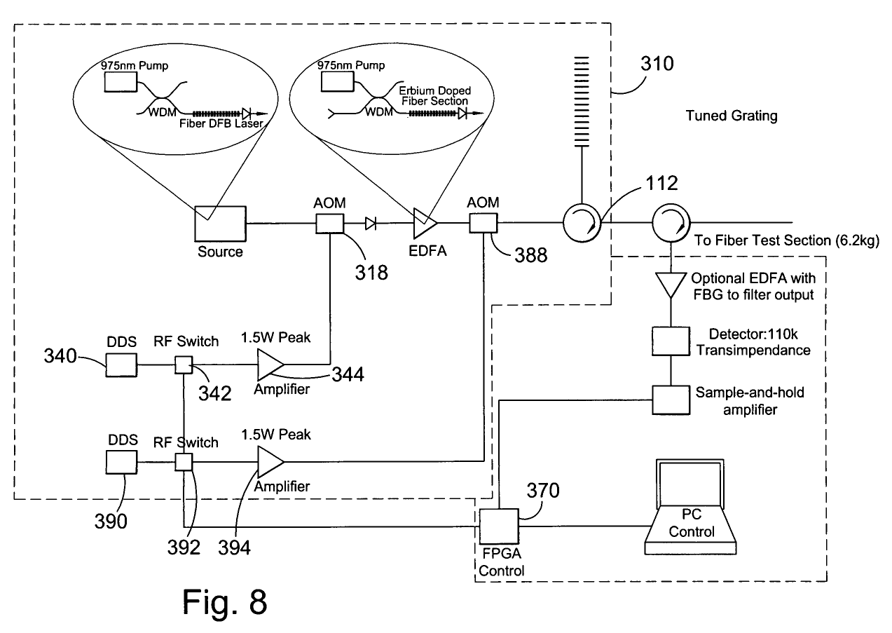

FIG. 8 shows a third embodiment of the invention. The third embodiment is similar to the first embodiment and the additions of the second embodiment may also be used with this third embodiment.

Elements of the third invention corresponding to those of the first embodiment will retain the first embodiment numbering. The third embodiment differs from the first embodiment in that a second AOM 388 is included in the source 110 between the EDFA 116 and the bandwidth filter 120.

The third embodiment comprises drive signal generation elements for the second AOM 388. Additionally, the first AOM 318, DDS 340, RF switch 342 and amplifier 344 are also modified from that described in the first embodiment.

The drive signal generation elements for the second AOM 388 are the same as those for the first AOM 118 of the first embodiment. A DDS 390 generates a signal at 80 MHz, an RF Switch 392, which is controlled by control stage 370, switches the signal from the DDS 390. The resulting signal is amplified by an amplifier 394 before being input into the second AOM 388.

As stated above, the first AOM 318, DDS 340, RF switch 342 and amplifier 344 are modified from that described in the first embodiment. DDS 340 generates a signal at 80 MHz, rather than 110 MHz. RF switch 342 receives control signals from control stage 370, and switches the generated signals from the DDS 340, which are then amplified using amplifier 344 with a power of 2 W peak.

The effect of the addition of the second AOM 388 is to block amplified spontaneous emission from the first EDFA 116 between pulses, so reducing ASE in the fibre-optic cable with the backscattered radiation caused by the pulses generating noise in the detection stage.

Other than the above, the third embodiment may operate in generally the same way as described in relation to the first embodiment.

Instead of AOMs, other types of optical switches can alternatively be used in the invention.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A sensing apparatus for sensing disturbances in an optic communication or transmission media, comprising:
a source of pulses of coherent radiation;
an input and receiving stage connected to the source to input pulses of radiation into the optic communication or transmission media at a first end and to receive radiation backscattered by the optic communication or transmission media caused by the pulses input into the optic communication or transmission media;
a detecting stage connected to the input and receiving stage to detect a property of the backscattered radiation caused by the pulses as a function of the time elapsed after a predetermined time; and
a comparison stage to compare the detected backscattered radiation caused by different pulses input into the optic communication or transmission media.

2. The sensing apparatus as in claim 1, further comprising an indicating stage connected to the detecting stage to indicate the distance along the optic communication or transmission media at which a disturbance has occurred using the time elapsed between each pulse entering the optic communication or transmission media and detecting the backscattered radiation caused by the pulse and indicative of a disturbance to the optic communication or transmission media.

3. The sensing apparatus as in claim 1, further comprising an indication generator to output a signal indicative of the presence of a disturbance to the optic communication or transmission media based on the result of the comparison.

4. The sensing apparatus as in claim 3, wherein the indication generator is arranged to indicate the distance of the disturbance along the optic communication or transmission media from the first end, based on the result of the comparison.

5. The sensing apparatus as in claim 1, further comprising at least one sample and hold amplifier, to repeatedly sample a value of the output of the detection stage to hold the value for output until a new sample is taken.

6. The sensing apparatus as in claim 1, wherein the detecting stage is adapted to detect the intensity of the backscattered radiation caused by the pulses as a function of time.

7. The sensing apparatus as in claim 1, further comprising a processor to control one or more of the source, input and receiving stage, detecting stage and comparison stage.

8. The sensing apparatus as in claim 1, wherein the input and receiving stage comprises a circulator.

9. The sensing apparatus as in claim 1, wherein the source comprises a laser, an amplifier and a high speed switch.

10. The sensing apparatus as in claim 1, wherein the comparison stage is adapted to correlate the detected backscattered radiation, as a function of time, caused by different pulses input to the communication or transmission media.

11. A method of sensing disturbances in an optic communication or transmission media, comprising:
inputting pulses of coherent radiation into the optic communication media;
receiving backscattered radiation from the optic communication or transmission media caused by the pulses input into the optic communication or transmission media;
detecting a property of the backscattered radiation as a function of the time elapsed after a predetermined time; and
comparing the intensity of detected backscattered radiation of different pulses input into the optic communication or transmission media.

12. The method as in claim 11, further comprising determining the distance along the optic communication or transmission media at which the disturbance has occurred by using the time elapsed after said predetermined time.

13. The method as in claim 11, wherein successive pulses are correlated.

14. The method as in claim 12, wherein successive pulses are correlated.

15. The method as in claim 11, wherein said predetermined time is the time after entry of the pulse into the optic communication or transmission media.

16. The method as in claim 11, further comprising sampling the detected signals at discrete intervals and processing the sampled signals.

17. The method as in claim 11, wherein the comparison is a correlation of detected backscattered radiation, as a function of time, caused by different pulses input into the optic communication or transmission media.

18. A sensing apparatus for sensing disturbances in an optic communication media, the apparatus comprising:
generation means for generating pulses of coherent radiation;
input and receiving means for inputting the pulses of radiation into the optic communication or transmission media and for receiving radiation backscattered by the optic communication or transmission media caused by the pulses into the optic communication or transmission media;
detection means for detecting the intensity of the backscattered radiation caused by the pulses as a function of the time elapsed after a predetermined time; and
comparing means for comparing the backscattered radiation caused by different pulses input into the optic communication or transmission media.
